(19) United States
(12) Patent Application Publication
(10) Pub. No.: US 2020/0408232 A1
(43) Pub. Date: Dec. 31, 2020

(54) MOUNTING STRIP

(71) Applicant: Slide2Seal Ltd., Kerem Ben Zimra (IL)

(72) Inventors: Yoram Nir, Yesud Hamaala (IL); Eyal Shay, Yiron (IL)

(21) Appl. No.: 16/975,588

(22) PCT Filed: Feb. 25, 2019
(86) PCT No.: PCT/IL2019/050212

§ 371 Date: Aug. 25, 2020

Related U.S. Application Data
(60) Provisional application No. 62/634,939, filed on Feb. 26, 2018.

(51) Int. Cl. F16B 5/06; A47H 13/00

(52) U.S. Cl. CPC F16B 5/0692; A47H 13/00

(57) ABSTRACT

A mounting strip includes a strip element and a plurality of engagement elements. Each engagement element includes: an anchor portion configured for anchoring the respective engagement element to the strip element; and an engagement portion including a through-opening. At least the anchor portion is provided as an injection molded article, directly molded onto the strip element.

### TECHNOLOGICAL FIELD

The presently disclosed subject matter relates to mounting arrangements for sheet elements, in particular for enabling the mounting of sheet elements to a structure.

### BACKGROUND ART

References considered to be relevant as background to the presently disclosed subject matter are listed below:
GB 201313348
GB 2481234

Acknowledgement of the above references herein is not to be inferred as meaning that these are in any way relevant to the patentability of the presently disclosed subject matter.

### BACKGROUND

There are a variety of structures in which a flexible panel, for example made from a fabric or net, is required to be secured to the structure via ropes, cables, elasticated straps and the like. Such panels can include curtains, truck cargo container openings, banners, building facades, building wraps, shade nets, protective nets and the like, for example Conventionally, such flexible panels are provided with eyelets, grommets or other connectors, which are first manufactured and then affixed to the panels, along one or more edges of the panels. The ropes, cables, elasticated straps or the like can be looped directly through the eyelets/grommets/connectors, or indirectly via rings that are in turn looped through the eyelets/grommets. Some examples of grommets or connectors sometimes used with nets include the “net connector with bridge”, model 8200 or the “net connector” model 8100, 8100bh, both provided by Paskal, Israel, and the “Folienplakette WIESEL Universal PA SET; 8Stk”, model F50010SET, provided by Fruit Security Austria.

By way of general background, GB 201313348 describes a curtain lining kit, curtain assembly and method for retrofitting or adding a lining to a separate eyelet curtain. The method involves attaching a plurality of curtain hooks to curtain tape attached to a sheet of lining material and attaching the hooks to curtain rings which have been arranged between the eyelets of an eyelet curtain on a curtain pole. The assembly disclosed comprises a curtain pole, an eyelet curtain mounted on the pole, a lining with attached curtain tape and hooks arranged on the pole through curtain rings which are disposed between the eyelets such that when viewed the curtain rings and lining are not significantly visible.

Also by way of general background, GB 2481234 discloses a curtain lining kit for adding a lining to a separate eyelet curtain mountable upon a curtain rod without attaching the lining to the eyelet curtain comprises at least one sheet of lining material having a curtain tape attached along and adjacent an upper edge thereof. The kit can further include a plurality of hooks attachable to the curtain tape and a plurality of curtain rings each attachable to a respective one of the curtain hooks. In another embodiment, the at least one sheet of lining material is provided with pairs of adjacent eyelets through which a curtain rod is passed in use. In use, the drop of the first sheet of lining material is less than the drop of the eyelet curtain with which the lining is to be used. The curtain lining kit allows an eyelet curtain to be retrofitted with a lining.

### General Description

According to a first aspect of the presently disclosed subject matter there is provided a mounting strip comprising a strip element and a plurality of engagement elements, each said engagement element including: an anchor portion configured for anchoring the respective engagement element to the strip element; and an engagement portion including a through-opening; wherein at least the anchor portion is provided as an injection molded article, directly molded onto said strip element.

For example, the mounting strip is for use with a panel element, the panel element being different from the panel element.

For example, the mounting strip can comprise an elongate configuration having a longitudinal dimension at least twice a width dimension thereof.

In at least some examples, the mounting strip is configured for affixing the mounting strip with respect to a panel element. Thus at least in such examples the mounting strip is different from the panel element, and optionally the width of the mounting strip is significantly less than the width of the panel element. In other examples the mounting strip is configured as a multi-purpose belt or strap, for facilitating mounting multiple items thereto, for example

For example, each said engagement element can be provided as an injection molded article, directly molded onto said strip element.

Each engagement portion can be detachably attachable to a respective one of the anchor portions.

The anchor portion can comprise a body interface and the engagement element can comprise an engagement portion interface configured to interface with and be connected to the body interface.

The interfacing can be via any one or more of a screw and thread arrangement, an adhesive connection between a protrusion and a recess or a snap-fit arrangement.

The strip element can comprise a plurality of holes at spaced apart locations along the strip element; wherein the anchor portions can each be formed superposed at one of the plurality of holes, having a first anchor portion and second anchor portion arranged above and below the strip element respectively, such that the first and second anchor portions are connected to one another via a connected portion passing through one of the holes.

The mounting strip can comprise at least one cordelle at an edge of the strip element, and a slot in each of the anchor portions. The slot can comprise a circular portion arranged to engage with the cordelle.

Additionally or alternatively, for example, said through opening can define a passage axis different from a longitudinal axis of the anchor portion. For example, said passage axis can be substantially parallel to said longitudinal axis, or said passage axis can be substantially orthogonal to said longitudinal axis, or said passage axis can be at an acute angle to said longitudinal axis.

The engagement portion can include a loop structure defining said through-opening therein.

The loop structure can be in the form of a body of material at least partially circumscribing and thereby defining the through-opening.

The body of material can comprise at least one partial ring-shaped structure having an opening in the ring structure. The opening can be a gap either at a central portion of the ring distal from the anchoring portion, or at a side portion of the ring between the central portion and the anchoring portion.

The relative sizes of the gap and the through-opening can be such as to allow the loop-structure to engage with a cable passing through the through-opening, and to allow the loop-structure to become disconnected from the cable via the gap under loads above a pre-determined threshold.

A transverse cross-sectional area of the through-opening can be configured to be larger than a transverse cross-sectional area of a connection element configured to be passed therethrough.

The loop structure can be in the form of a body of material fully circumscribing and defining the through-opening. A first part of the loop structure can be defined by the base element, while a second part of the loop structure can be defined by a C-shaped element joined to the base element. The through-opening can be configured to allow passage of a connection element through the loop structure along a passage axis.

In at least some examples, the engagement elements can be arranged on a first edge portion of the strip element.

The mounting strip can comprise two layers joined together at the first edge portion and which, when not connected to a panel, can be separated at a second edge portion of the strip element.

The engagement elements can be a first set of engagement elements, and the mounting strip can comprising a second set of engagement elements arranged on a second edge portion of the strip element, the second edge portion being located at an edge of the strip opposite from that at which the first edge portion is located.

According to a second aspect of the presently disclosed subject matter there is provided a mounting strip comprising a strip element and a plurality of engagement elements, each said engagement element including: an anchor portion configured for anchoring the respective engagement element to the strip element; wherein at least the anchor portion is provided as an injection molded article, directly molded onto said strip element; and wherein, in use, the anchor portion is configured to interface with an engagement portion.

The mounting strip can include an engagement portion provided for each anchor portion, each engagement element comprising the anchor portion and the engagement portion. Each engagement portion can comprise a through-opening.

According to a third aspect of the presently disclosed subject matter there is provided an assembly including a panel element and at least one mounting strip, wherein the least one mounting strip is affixed with respect to the panel element, the mounting strip being as defined according to the first or second aspect of the presently disclosed subject matter.

The mounting strip can be affixed at a second edge portion thereof to the panel element.

The mounting strip can comprise a central portion free of said engagement elements. The mounting strip can be affixed at the central portion thereof to the panel element.

The mounting strip is affixed to an edge of the panel element, or to a portion of the panel element spaced from an edge thereof.

The mounting strip can be affixed to an edge of the panel element, the edge of the panel element being affixed in-between the two layers of the mounting strip at the second edge portion thereof.

Affixing can comprises at least one of sewing, stapling, welding, melting or adhering.

The panel element can comprising at least one further mounting strip affixed thereto.

According to a fourth aspect of the presently disclosed subject matter, there is provided a method for providing a plurality of engagement elements on a strip element, the engagement elements each comprising an anchor portion configured for anchoring the respective engagement element to the strip element; and an engagement portion including a through-opening, the method comprising: injection molding a plurality of anchor portions spaced apart along an edge of the strip element; and providing an engagement portion for each anchor portion.

The method may comprise at least one of injection molding, interfacing or connecting, each of the engagement portions to a respective one of the anchor portions.

The engagement and anchor portions may be formed in a single step by injection molding.

The method may comprise: providing a plurality of holes at spaced apart locations along the strip element; and forming each of the anchor portions superposed at one of the holes, having a first anchor portion and second anchor portion arranged above and below the strip element respectively, such that the first and second anchor portions are connected to one another via a connected portion passing through one of the holes.

The method may comprise: providing a cordelle at an edge of the strip element, and a slot in each of the anchor portions, the slot comprising a circular portion arranged to engage with the cordelle.

According to a fifth aspect of the presently disclosed subject matter, there is provided a method for fixing a mounting strip to an edge of a panel element, or to a portion of a panel element spaced from an edge thereof, comprising: providing a mounting strip as defined in the first or second aspect, the method comprising affixing the mounting strip to a panel element.

Affixing can comprise at least one of sewing, stapling, welding, melting or adhering.

Affixing can comprise affixing an edge of the mounting strip, or a central portion of the mounting strip, to an edge of a panel element, or to a portion of a panel element spaced from an edge thereof.

According to a sixth aspect of the presently disclosed subject matter, there is provided a structure comprising: an assembly as defined in the third aspect; a plurality of mounting points; and at least one connection element; wherein the engagement portions of the engagement elements of the assembly are connected to the plurality of mounting points by the at least one connection element.

The at least one connection element can comprise a cord element threaded in an alternating fashion between the mounting points and the loop structures of the engagement portions.

The at least one connection element can comprise a plurality of hooks, each arranged to connect one of the loop structures of the engagement portions to one of the mounting points.

According to a seventh aspect of the presently disclosed subject matter, there is provided a mounting strip comprising a strip element and a plurality of engagement elements, each said engagement element including:

an anchor portion configured for anchoring the respective engagement element to the strip element; and

an engagement portion including a through-opening;

wherein at least the anchor portion is provided as an injection molded article, directly molded onto said strip element

and wherein the mounting strip is the form of a panel element

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a top partially cutout view of a mounting system and mounting strip according to a first example of the presently disclosed subject matter;

FIG. 1(a) is a transverse cross-sectional view of a strip member of the mounting strip of the example of FIG. 1;

FIG. 1(b) is a transverse cross-sectional view of the mounting strip corresponding to the example of FIG. 1(a);

FIG. 2(a) is a transverse cross-sectional view of a strip member of the mounting strip according to an alternative example to that of FIG. 1(a);

FIG. 2(b) is a transverse cross-sectional view of the mounting strip corresponding to the example of FIG. 2(b);

FIGS. 3(a), 3(b), 3(c), 3(d) show in isometric view, top view, side view, and cross-sectional side view along the plane A-A in FIG. 3(b), respectively, an engagement element according to a first example of the presently disclosed subject matter;

FIGS. 4(a), 4(b), 4(c), 4(d) show in isometric view, top view, side view, and front view, respectively, an engagement element according to an alternative variation of the example of FIGS. 3(a), 3(b), 3(c), 3(d);

FIG. 5 schematically illustrates an implementation of the examples of FIGS. 1 to 4(d);

FIG. 6 schematically illustrates another implementation of the examples of FIGS. 1 to 4(d);

FIGS. 7(a), 7(b), 7(c), 7(d) show in isometric view, top view, side view, and front view, respectively, an engagement element according to an alternative variation of the example of FIGS. 4(a), 4(b), 4(c), 4(d);

FIGS. 8(a), 8(b), 8(c), 8(d) show in isometric view, top view, side view, and front view, respectively, an engagement element according to another alternative variation of the example of FIGS. 4(a), 4(b), 4(c), 4(d);

FIGS. 9(a), 9(b), 9(c), 9(d) show in isometric view, top view, side view, and front view, respectively, an engagement element according to another alternative variation of the example of FIGS. 4(a), 4(b), 4(c), 4(d);

FIG. 9(e) shows in isometric view, an engagement element according to another alternative variation of the example of FIGS. 9(a), 9(b), 9(c), 9(d);

FIGS. 10(a), 10(b), 10(c) show in isometric view, side view and top view, respectively, an engagement element according to an alternative variation of the example of FIGS. 4(a), 4(b), 4(c), 4(d);

FIG. 10(d) shows in isometric view, an engagement element according to another alternative variation of the example of FIGS. 10(a), 10(b), 10(c);

FIGS. 11(a), 11(b), 11(c), 11(d) show in isometric views, various options for an engagement element according to another alternative variation of the example of FIGS. 4(a), 4(b), 4(c), 4(d);

FIG. 12 is a transverse cross-sectional view of a strip member of the mounting strip of the example of FIG. 1 in alternative mounting arrangement with respect to a panel;

FIG. 13 is a transverse cross-sectional view of a strip member of the mounting strip of an alternative variation of the example of FIG. 1; and

FIG. 14 is a transverse cross-sectional view of a strip member of the mounting strip of the example of FIG. 13 in mounting arrangement with respect to a panel according to one example.

### DETAILED DESCRIPTION

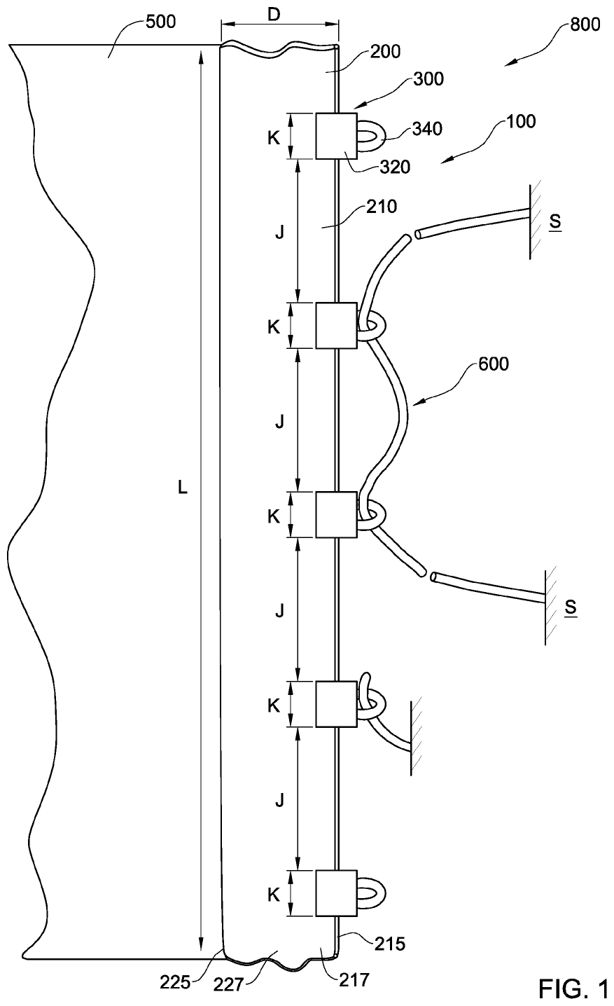

Referring to FIG. 1, a mounting strip (also referred to interchangeably herein as a strip, or as a compound strip, or as a mounting tape, or as a compound tape, or as a tape) according to a first example of the presently disclosed subject matter, generally designated 100, comprises a strip element 200 (also referred to interchangeably herein as a “tape element” and a “strip member”) and a plurality of engagement elements 300.

In at least some examples, the mounting strip 100 is configured for mounting the mounting strip to a sheet element or panel 500, and for thereby enabling the panel element 500 to be secured to a structure S or the like, optionally including another panel 500, via a connection element 600 to provide an assembly. A mounting system 800 is thereby provided comprising at least one sheet element 500 comprising at least one mounting strip 100, and at least one connection element 600.

The provision of a mounting strip 300 separate from the panel element 500 can lead to facilitating the affixing of the engagement elements 300 indirectly to the panel element 500 by means of the ready-to-use mounting strip 100 to form a respective assembly,

Herein, “sheet”, “sheet element”, “panel” and “panel element” are used interchangeably. The panel 500 is made from any suitable or desired flexible sheet material, and can include, for example, sheets that are essentially continuous (and do not have any grids or through-holes), or for example that are essentially non-continuous, i.e., in the form of a mesh or net (and thus have grids of through-holes, each having an open area, and the ratio of the open area to the closed area (provided by the actual material of the panel) can be 1, or less than 1, or greater than 1).

The panel can be for use, for example, as the whole or part of a curtain, truck cargo container opening, banner, building facade, building wrap, shade net, protective net and the like.

For example, the sheets can be made from fabric or textile comprising natural and/or synthetic yarns, for example nylon, polyester, acrylic or other synthetic yarns, plastic material, for example PVC, Polyethylene or Polyurethane, canvas, technical yarns such as Kevlar®, Technora®, Nomex®, Dyneema® and Vectran®, and so on, wherein the fabric can optionally be coated with a suitable coating, such as waterproof, stiffening or other coatings for example. The fabric is optionally capable of being rolled into a compact spiral configuration, for example with respect to a roll axis aligned with a width direction of the panel, and for being unrolled into at least a flat configuration. In at least some examples, the panel 500 is made from a flexible material that is not elastically stretchable, or is only mildly stretchable, or substantially stretchable, at least when subjected to regular loads, i.e., the loads for which the panel 500 is rated during regular use thereof. While the panel 500 can have any suitable shape, in this and other examples the panel 500 has a nominally rectangular shape, having a longitudinal dimension (parallel to a longitudinal dimension of the mounting strip 100) that is larger than a width dimension of the panel 500, and the longitudinal dimension and the width dimension of the panel 500 are each significantly greater than a thickness or depth dimension thereof. In alternative variations of this example, the width dimension can be the same size or larger than the longitudinal dimension.

In at least this example, the connection element 600 is in the form of a cord element, comprising a suitable length of flexible material than can be looped, or entwined, with the engagement elements 300 and where desired transfer mechanical loads (static loads and/or dynamic loads) between the panel 500 and the structure. Thus, in at least this example, the engagement elements 300 are in the form of cord-engaging elements.

Herein “cord element”, “cord”, “cable element”, “cable”, “string element”, “string”, “rope element” and “rope” are used interchangeably. In general the connection element 600 in the form of a cord element that can carry and transfer tensile loads but not compressive loads. To this end, the cord element can be, for example, in the form of an elasticated bungee or in the form of a cable. Alternatively, the connection element 600 can be in the form of a pole, or a hook, for example, and can carry loads in tension and/or in compression.

In at least this example, and referring to FIGS. 1, 1(a) and 1(b), the strip element 200 is generally elongate, having a (longitudinal) length dimension L, width dimension D and thickness dimension t. In at least some applications of this and other examples, the length dimension L is so-called “endless”; in other words the strip element 200 of a desired length dimension L can be cut or otherwise separated from a roll (or reel or other packaging arrangement) of strip element in which the longitudinal length of the strip element can be much greater than the desired length. Thus, for at least this example, the length dimension L for a particular strip element 200 can be varied to suit a particular application, while the width D and thickness t dimensions are maintained constant. Of course, it is also alternatively possible to provide strip elements 200 of many different combinations of length dimension, width dimension and thickness dimension, each having any desired length dimension L and/or any desired width dimension D and/or any desired thickness dimension t.

The strip element 200 comprises an upper surface 210 and lower surface 220, separated by the thickness dimension t. The strip element 200 comprises a longitudinal first edge portion 217 including longitudinal first edge 215, running along a direction parallel to the length dimension L. The strip element 200 comprises also comprises a longitudinal second edge portion 227 including longitudinal second edge 225, running along a direction parallel to the length dimension L. The longitudinal first edge 215 is spaced from the longitudinal second edge 225 by the width dimension W.

The strip element 200 comprises at least one cordelle, and in at least this example, the strip element 200 comprises one cordelle 230 affixed to the strip element 200 at the longitudinal first edge portion 214 proximate the longitudinal first edge 215. Herein by “cordelle”, is meant a thread element or cord for example as described below, which, when enclosed within the strip element 200 proximate to the longitudinal first edge 215 thereof, provides reinforcement thereto. Such enclosure can be provided for example during an extrusion process of the strip element 200, or can involve a separate step of folding an edge of the strip element 200 over and around the thread element, and subsequently securing the thread element in place using attachment arrangements such as adhesives, mechanical fixings such as sewing and stapling, applied heat and/or pressure, etc, and/or by friction. The cordelle 230, when affixed to the strip element 200, has an effective outer diameter D. The cordelle 230 is continuous and generally co-extensive with longitudinal first edge 215. In alternative variations of this example, the cordelle can be interrupted, and thus there can be one or more first regions of the longitudinal first edge portion 214 proximate the longitudinal first edge 215 in which there is no cordelle along the longitudinal first edge 215, interposed with one or more second regions of the longitudinal first edge 215 in which there is a cordelle along the longitudinal first edge 215. In yet other alternative variations of this example, the cordelle can be provided laterally displaced from the longitudinal first edge 215, so as to be distal therefrom. In yet other alternative variations of this example, strip element 200 comprises more than one cordelle—for example a first cordelle can be provided along the longitudinal first edge 215, and/or a second cordelle can be provided at the longitudinal second edge portion 227 proximate and along the longitudinal second edge 225, and/or one or more cordelle can be provided laterally displaced from the longitudinal first edge 215 and/or from the longitudinal second edge 225.

While in this example the strip element 200 comprises at least one cordelle 230, in some alternative variations of this example, the cordelle 230 can be omitted. The cordelle 230 is configured for reinforcing the first longitudinal edge portion 217, in particular the first longitudinal edge 215.

In at least this example each cordelle 230 is in the form of one or more thread element, having a diameter thicker than the thickness t of the strip element 200. The thread element(s) can be made from a fabric, rope, metal, natural or synthetic polymeric resin, composites and so on, can comprise a single element or multiple elements arranged in a row, and can be coated with a natural or synthetic coating, e.g. a PVC coating. The fabric of the cordelle element can made from natural and/or synthetic yarns, for example nylon, polyester, acrylic or other synthetic yarns, similar to fabrics described above for the sheet element 200.

Many examples of strip elements having a cordelle element are commercially available.

In this and other examples, the mounting strip 100 can be affixed to the panel 500 using any suitable fixing method, for example via mechanical fixing (for example staples, stitching, sewing, etc.) or welding (for example ultrasonic welding, heat welding, etc.), or via bonding (for example using suitable adhesives optionally including application of heat and/or pressure, e.g. with contact adhesives). Alternative arrangements for affixing include, but are not limited to, clips, studs, rivets, buttons, etc. Any suitable combination for the above affixing arrangements can be used, and the affixing may be a permanent affixing, or a reversible affixing.

The strip element can be made from fabric or textile comprising natural and/or synthetic yarns, for example nylon, polyester, acrylic or other synthetic yarns, plastic material. For example, the strip element 200 can be made from one or more of the following: PVC (Polyvinyl chloride), PE (Polyethylene), PP (Polypropylene), PA (Polyamide), PES (Polyester), Polyurethane, canvas, technical yarns such as Kevlar®, Technora®, Nomex®, Dyneema® and Vectran®, and so on, wherein the fabric can optionally be coated with a suitable coating, such as waterproof, stiffening or other coatings for example.

In this example, and referring to FIG. 1(b), the mounting strip 100 is affixed to the panel 500 via widthwise overlap between respective overlapping portions of the panel 500 and of the mounting strip 100, including part or all of the lower surface 220 of the strip element 200 and a longitudinal edge portion 510 of the panel 500 in overlying relationship with the lower surface 220 of the strip element 200.

In alternative variations of this example, the mounting tape 100 can be affixed to the panel 500 by being formed integrally therewith.

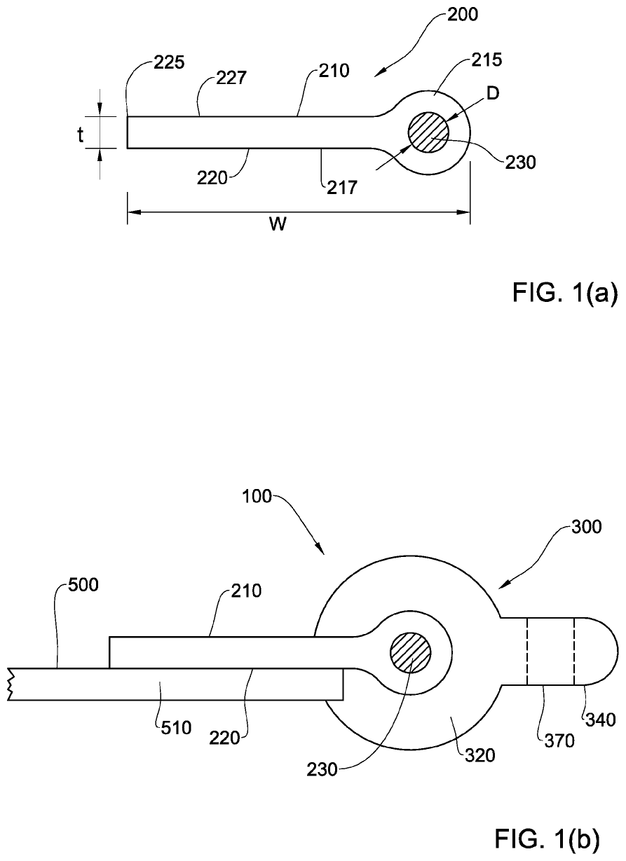

In other alternative variations of this example, and referring to FIGS. 2(a) and 2(b), for example, the strip element 200 has a longitudinal second edge portion 227 that comprises two layers 200A, 200B, joined together at the longitudinal first edge portion 217 which includes the longitudinal first edge 215 and the cordelle 230. The second edge portion 227 is initially open, as illustrated in FIG. 2(a), and the longitudinal second edge 225 of the strip element 200 is provided by the transversely separated second edges 225A and 225B of the two layers 200A, 200B, respectively. As shown in the example of FIG. 2(b), the mounting strip 100 is affixed to the panel 500 by first inserting the longitudinal edge portion 510 of panel 500 in-between the two layers 200A, 200B, which are then in widthwise overlapping relationship with the longitudinal edge portion 510. Thereafter the panel 500 is affixed to the mounting strip 100 by affixing the longitudinal edge portion 510 of panel 500 in-between the two layers 200A, 200B, using any suitable fixing arrangement or method, for example via mechanical fixing (for example staples, stitching, sewing, etc.) or welding (for example ultrasonic welding, heat welding, etc.), or via bonding (for example using suitable adhesives optionally including application of heat and/or pressure, e.g. with contact adhesives).

Referring again to FIG. 1, the mounting strip 100 comprises a plurality of engagement elements 300 affixed at least to the first edge portion 217 including longitudinal first edge 215, and optionally also to at least part of the second edge portion 227, in a longitudinal serially spaced relationship, i.e., along the longitudinal dimension L of the mounting strip 100.

In at least this example, each engagement element 300 is formed as a unitary article and comprises an anchor portion 320 and an engagement portion 340 projecting outwardly from the anchor portion 320 in a direction away from the strip element 200, in particular in a transverse direction away from the strip element 200. Thus, in at least this example, and also in other examples, the anchor portion 320 is different from the engagement portion 340

The anchor portion 320 is configured for anchoring the respective engagement element 300 to the strip element 200, in particular with respect to the first edge portion 217 including longitudinal first edge 215, and optionally also including at least a portion of the second edge portion 227.

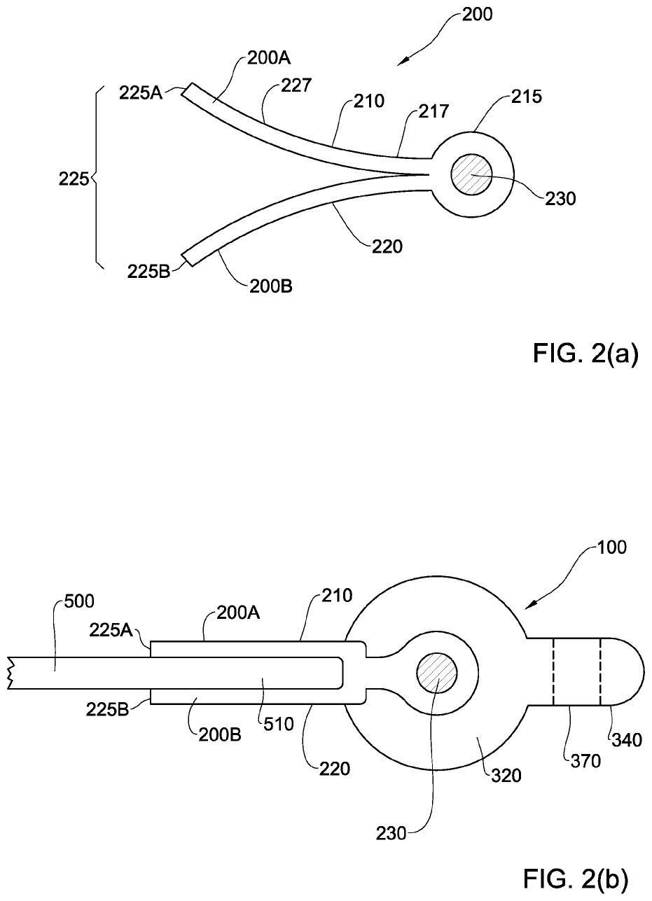

Referring also to FIGS. 3(a) to 3(d), in this example the anchor portion 320 includes a body 325 of suitable material, typically a solid body, in a generally quadrilateral prismatic form with respect to a longitudinal axis AA, of generally rectangular cross-sectional area along lateral planes orthogonal to longitudinal axis AA. The body 325 has a transverse slot 330 extending outwardly from or near to the axis AA. The slot 330 is longitudinally coextensive with the body 325, and thus extends between two longitudinal ends 332, 334 of the body 325. The transverse cross-sectional shape of the slot 330 includes a generally rectangular portion 336 of width T1 and a circular portion 337 connected to an inner end of the rectangular portion 336, the circular portion 337 having a diameter D1. A profile or shape of the slot 330 is complementary to a transverse cross-sectional profile or shape of the first edge portion 217 including longitudinal first edge 215 and cordelle 230, and thus width T1 and diameter D1 correlate to (and are nominally equal to) the thickness t of the strip element 200 and the outer diameter at the cordelle 230 (including the diameter D of the cordelle 230 plus the thickness (2*t) of fabric or material around the cordelle 230), respectively.

In view of the slot 330, the body 325 can also be considered to have a generally inverted-U shaped transverse cross-section, with two anchoring element 322, 324 joined to a base element 326. The anchoring element 322, 324 are configured to be located on opposite sides of the strip element 200, and thus when engagement element 300 is affixed to the strip element 200, the anchoring elements 322, 324 are in gripping relationship with the upper surface 210 and lower surface 220, respectively, of the strip element 200.

In at least this example, the engagement portion 340 is joined with the body 325, in particular with the base element 326. Such joining may be by application of fixing arrangements such as welding and adhering for example, or can be by integral forming, such as by casting, injection molding or other methods for example. The engagement portion 340 includes a loop structure 360 defining an opening 370 therein.

As will become clear herein, in at least this example, engagement portion 340, in particular the loop structure 360, is in the form of a solid body of material. The solid body of the loop structure 360 comprises a base edge 360c joined with the base element 326 along a length thereof parallel to the longitudinal axis thereof, such that two longitudinal ends 360a, 360b of the loop structure extend to the two longitudinal ends 332, 334 of the body 325. The respective opening is circumscribed and thereby defined by the loop structure 360 and in this example takes the form of a circular bore passing therethrough along a passage axis PA.

In this example, as seen in FIG. 3(b), a profile of an outer surface the loop structure 360, when viewed in a plane perpendicular to the passage axis, comprises a central portion 360d spaced radially outwardly of the bore opening 370 in the form of an arc having a centre of curvature coincident with the passage axis PA and an arc length of less than 180°, and two sloped linear portions 360e, each being tangential to the central portion 360d at an end thereof and extending from the central portion 360d, away from the passage axis PA, to the two longitudinal ends 360a, 360b of the loop structure 360.

The opening 370 is dimensioned, for example having an open area and/or width, larger than the transverse dimensions of the respective connection element 600, for example the transverse cross-sectional area and/or transverse width (or diameter), respectively, of the connection element 600. In this connection, the term “transverse” refers to being along a plane perpendicular to a longitudinal direction of the connection element 600. In this manner, the connection element 600 can easily be threaded, looped or otherwise connected to and/or through the opening 370.

Referring in particular to FIGS. 3(a) and 3(b), in at least this example the loop structure 360 is in the form of a solid body of material fully circumscribing and thereby defining the opening 370. The opening 370 of the loop structure 360 allows for passage of the connection element 600 through the loop structure 360 along the passage axis PA.

Optionally, the body 325 can have a plurality of ridges 325a, for example in the form of transverse ribs, formed on the outer surface of the body 325 extending in a direction transverse to the longitudinal axis AA of the body 325.

In this example, the passage axis PA is nominally orthogonal to the longitudinal axis AA of the body 325.

By way of non-limiting example, FIGS. 3(b), 3(c) and 3(d) provide dimensional data (in mm) for various parts of the engagement element 300 (with general tolerance of, for example, ±0.05), according to one implementation of this example. In alternative implementations of this example, the dimensional data can be changed pro-rata, for example all annotated dimensions can be increased or decreased in the same proportion, for example can be increased by 50%, 100%, 150%, 200% and so on, or decreased by 10%, 25%, 50% and so on.

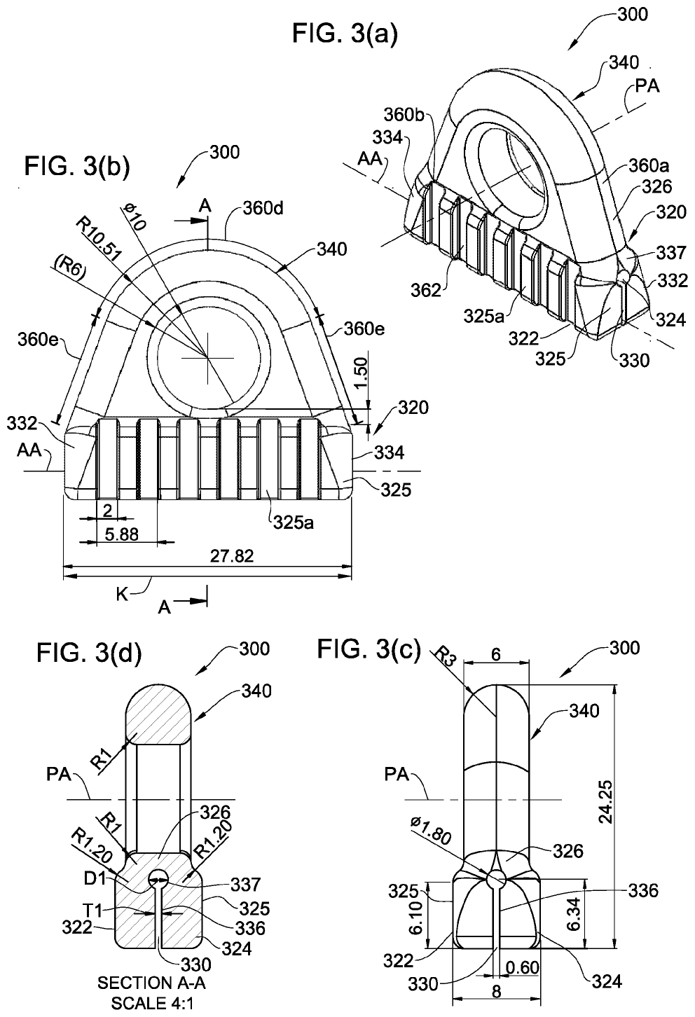

An alternative variation of the example of engagement element 300 of FIGS. 3(a) to 3(d) is illustrated in FIGS. 4(a) to 4(d).

Referring to FIGS. 4(a) to 4(d), in this example the anchor portion 320 includes a body 325 of suitable material, typically a solid body, in a generally cylindrical form with respect to a longitudinal axis AA. The body 325 has a radial slot 330 extending outwardly from or near to the axis AA. The slot 330 is longitudinally coextensive with the body 325, and thus extends between two longitudinal ends 332, 334 of the body 325. The transverse cross-sectional shape of the slot 330 includes a generally rectangular portion 336 of width T1 and a circular portion 337 connected to an inner end of the rectangular portion 336, the circular portion 337 having a diameter D1. A profile or shape of the slot 330 is complementary to a transverse cross-sectional profile or shape of the first edge portion 217 including longitudinal first edge 215 and cordelle 230, and thus width T1 and diameter D1 correlate to (and are nominally equal to) the thickness t of the strip element 200 and the outer diameter at the cordelle 230 (including the diameter D of the cordelle 230 plus the thickness (2*t) of fabric or material around the cordelle 230), respectively.

In view of the slot 330, the body 325 can also be considered to have a generally inverted-U shaped transverse cross-section, with two anchoring element 322, 324 joined to a base element 326. The anchoring element 322, 324 are configured to be located on opposite sides of the strip element 200, and thus when engagement element 300 is affixed to the strip element 200, the anchoring elements 322, 324 are in gripping relationship with the upper surface 210 and lower surface 220, respectively, of the strip element 200.

In at least this example, the engagement portion 340 is joined with the body 325, in particular with the base element 326. The engagement portion 340 includes a loop structure 360 defining an opening 370 therein.

As will become clear herein, in at least this example, engagement portion 340, in particular the loop structure 360, is in the form of a ring of material partially circumscribing and thereby defining the respective opening 370.

The opening 370 is dimensioned, for example having an open area and/or width, larger than the transverse dimensions of the respective connection element 600, for example the transverse cross-sectional area and/or transverse width (or diameter), respectively, of the connection element 600. In this connection, the term “transverse” refers to being along a plane perpendicular to a longitudinal direction of the connection element 600. In this manner, the connection element 600 can easily be threaded, looped or otherwise connected to and/or through the opening 370.

Referring in particular to FIGS. 4(a) and 4(b), in at least this example the loop structure 360 is in the form of a ring of material fully circumscribing and thereby defining the opening 370. In this example, one part 362 of the loop structure 360 is defined by the base element 326, while the remainder of the loop structure 360 is defined by a second, C-shaped part 364 joined to the base element 326. The opening 370 of the loop structure 360 allows for passage of the connection element 600 through the loop structure 360 along a passage axis PA.

Optionally, the body 325 can have a plurality of ridges 325a, for example in the form of longitudinal channels, formed on the outer surface of the body 325 extending in a direction parallel to the longitudinal axis AA of the body 325.

In this example, the passage axis PA is nominally orthogonal to the longitudinal axis AA of the body 325.

Thus, referring also to FIGS. 4(a) to 4(d), in this example the anchor portion 320 includes a body 325 of suitable material, typically a solid body, in a generally cylindrical form with respect to a longitudinal axis AA. The body 325 has a radial slot 330 extending outwardly from or near to the axis AA. The slot 330 is longitudinally coextensive with the body 325, and thus extends between the two longitudinal ends 332, 334 of the body 325. The transverse cross-sectional shape of the slot 330 includes a generally rectangular portion 336 of width T1 and a circular portion 337 connected to the inner end of the rectangular portion 336, the circular portion 337 having a diameter D1. The profile or shape of the slot 330 is complementary to the transverse cross-sectional profile or shape of the first edge portion 217 including longitudinal first edge 215 and cordelle 230, and thus width T1 and diameter D1 correlate to (and are nominally equal to) the thickness t of the strip element 200 and diameter D of the cordelle 230, respectively.

In view of the slot 330, the body 325 can also be considered to have a generally inverted-U shaped transverse cross-section, with two anchoring element 322, 324 joined to a base element 326. The anchoring element 322, 324 are configured to be located on opposite sides of the strip element 200, and thus when engagement element 300 is affixed to the strip element 200, the anchoring elements 322, 324 are in gripping relationship with the upper surface 210 and lower surface 220, respectively.

In at least this example, the engagement portion 340 is joined with the body 325, in particular with the base element 326. The engagement portion 340 includes a loop structure 360 defining an opening 370 therein.

As will become clear herein, in at least this example, engagement portion 340, in particular the loop structure 360, is in the form of a ring of material partially circumscribing and thereby defining the respective opening 370.

The opening 370 is dimensioned, for example has an open area and/or width, larger than the transverse dimensions of the respective connection element 600, for example the transverse cross-sectional area and/or transverse width (or diameter), respectively, of the connection element 600.

Referring in particular to FIGS. 4(a) and 4(b), in at least this example the loop structure 360 is in the form of a ring of material fully circumscribing and thereby defining the opening 370. In this example, one part 362 of the loop structure 360 is defined by the base element 326, while the remainder of the loop structure 360 is defined by a second, C-shaped part 364 joined to the base element 326. The opening 370 of the loop structure 360 allows for passage of the connection element 600 through the loop structure 360 along a passage axis PA.

Optionally, the body 325 can have a plurality of ridges 325a, for example in the form of longitudinal channels, formed on the outer surface of the body 325.

In this example, the passage axis PA is nominally orthogonal to the longitudinal axis AA of the body 325.

By way of non-limiting example, FIGS. 4(b), 4(c), 4(d) provide dimensional data (in mm) for various parts of the engagement element 300 (with tolerance of, for example, ±0.05), according to one implementation of this example. In alternative implementations of this example, the dimensional data can be changed pro-rata, for example all annotated dimensions can be increased or decreased in the same proportion, for example can be increased by 50%, 100%, 150%, 200% and so on, or decreased by 10%, 25%, 50% and so on.

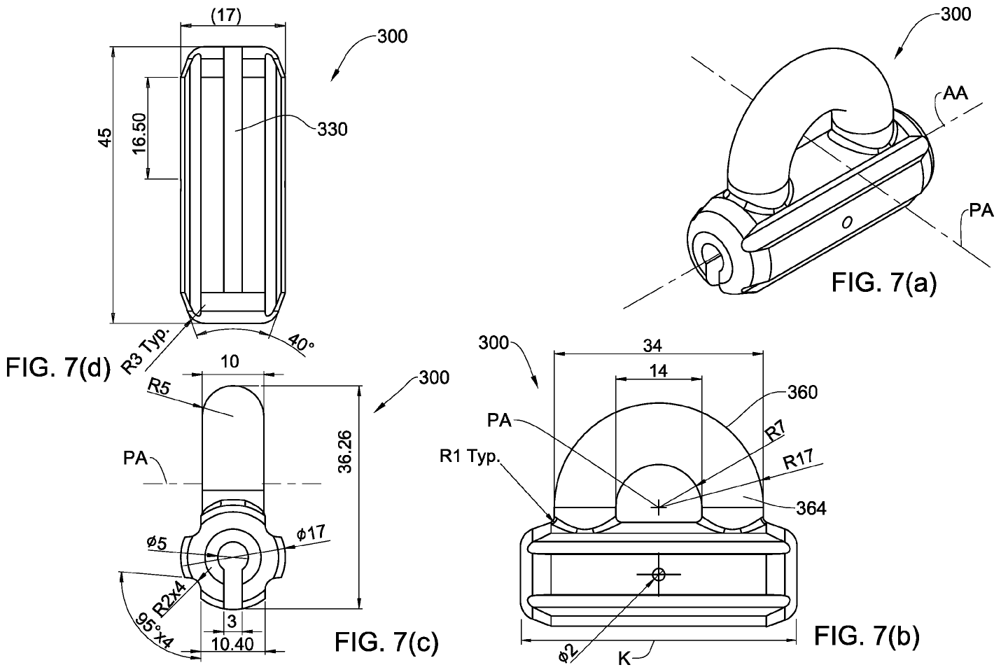

The following is applicable to any of the examples of FIGS. 3(a) to 3(d) and 4(a) to 4(d), or indeed, any of the examples in FIGS. 7(a) to 7(d), 8(a) to 8(d), 9(a) to 9(e), 10(a) to 10(d) and 11(a) to 11(d) described below.

As already mentioned, and referring again to FIG. 1, the engagement elements 300 are affixed to the first longitudinal edge 215 in longitudinal spaced relationship in which consecutive engagement elements 300 are longitudinally spaced from one another by a longitudinal spacing J (see FIG. 1). In this example the longitudinal spacing J is the same as, or greater than, the longitudinal dimension K of the body 325. For example, the ratio J:K can be any desired number from about 1 to about 30, or greater than 30, for example any one of 1.5, 2. 2.5, 3, 3.5, 4, 4.5, 5, 5.5, 6, 6.5, 7, 7.5, 8, 8.5, 9, 9.5, 10, 11, 12, 13, 14, 15, 16, 17, 18, 19, 20, 21, 22, 23, 24, 25, 26, 27, 28, 29, 30, 35, 40, 45, 50, 55, 60, 65, 70, 75, 80, 85, 90, 95, 100. Alternatively, the ratio J:K can be within any range N to M, wherein N is any number chosen from the group of 1.5, 2. 2.5, 3, 3.5, 4, 4.5, 5, 5.5, 6, 6.5, 7, 7.5, 8, 8.5, 9, 9.5, 10, 11, 12, 13, 14, 15, 16, 17, 18, 19, 20, 21, 22, 23, 24, 25, 26, 27, 28, 29, 30, 35, 40, 45, 50, 55, 60, 65, 70, 75, 80, 85, 90, 95, 100, and wherein M is any number chosen from the group of 1.5, 2. 2.5, 3, 3.5, 4, 4.5, 5, 5.5, 6, 6.5, 7, 7.5, 8, 8.5, 9, 9.5, 10, 11, 12, 13, 14, 15, 16, 17, 18, 19, 20, 21, 22, 23, 24, 25, 26, 27, 28, 29, 30, 35, 40, 45, 50, 55, 60, 65, 70, 75, 80, 85, 90, 95, 100.

In any case, in at least the above examples, the engagement elements 300 are injection-molded directly onto the strip member 200, and are made from a material suitable for this purpose, for example thermoplastic materials, including any one or more of the following materials, for example: POM (Polyoxymethylene), PBT (Polybutylene terephthalate), PA (Polyamide), acrylic polymers such as PMMA (polymethylmethacrylate), PPS (polyphenylene sulfide), and so on. For this purpose, and according to one example, the strip member 200 is placed into a suitable mold having a plurality of serially disposed mold cavities, each corresponding and complementary to the outer shape of the engagement element 300 to be formed, and suitable material is injected into the mold cavities to thereby form by injection molding the respective engagement elements 300 directly onto the strip member 200.

Optionally, the strip member 200 can be formed with at least one through-hole (not shown) formed at a location at which each anchoring element 322, 324 is to be formed in a superposed manner. Thus, as the anchoring elements 322, 324 are injection-molded onto the strip member 200, integrally straddling the first edge 215 and cordelle 230, the anchoring elements 322, 324 further include an integral and uninterrupted material connection between the two the anchoring elements 322, 324 via the through-hole.

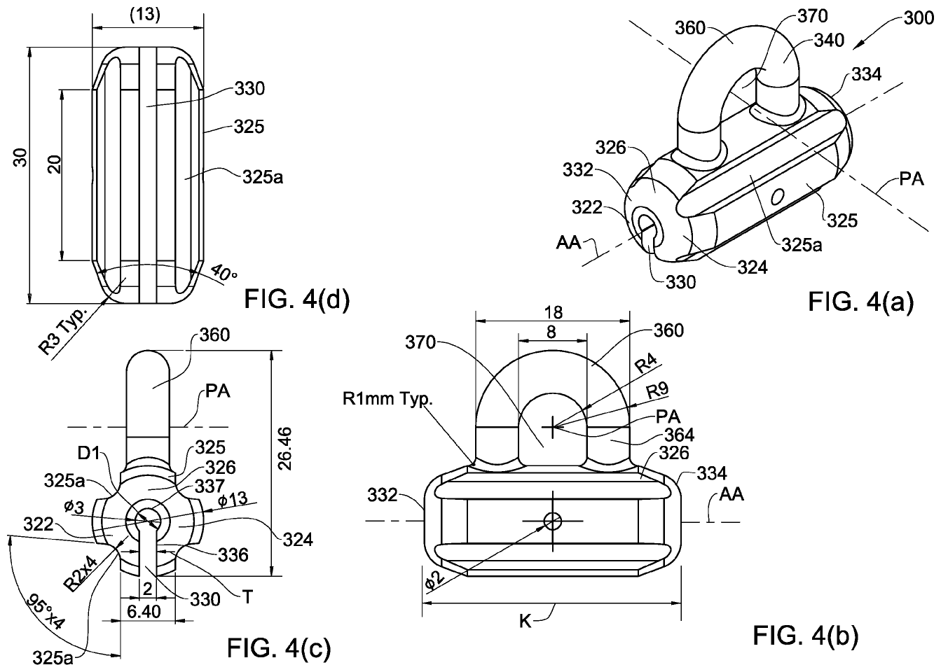

In one example, and referring to FIG. 5, in one application of the above example, two panels 500 are placed side by side such that their respective mounting strips 100 are facing one another. The two panels 500 are secured together by passing a connection element 600, in the form of a cord element, through the respective openings 370 of the respective engagement elements 300 of the respective mounting strips 100 in an alternating manner between the panels 500. Applying tension to the connection element 600 brings the two panels 500 together and secures the two together.

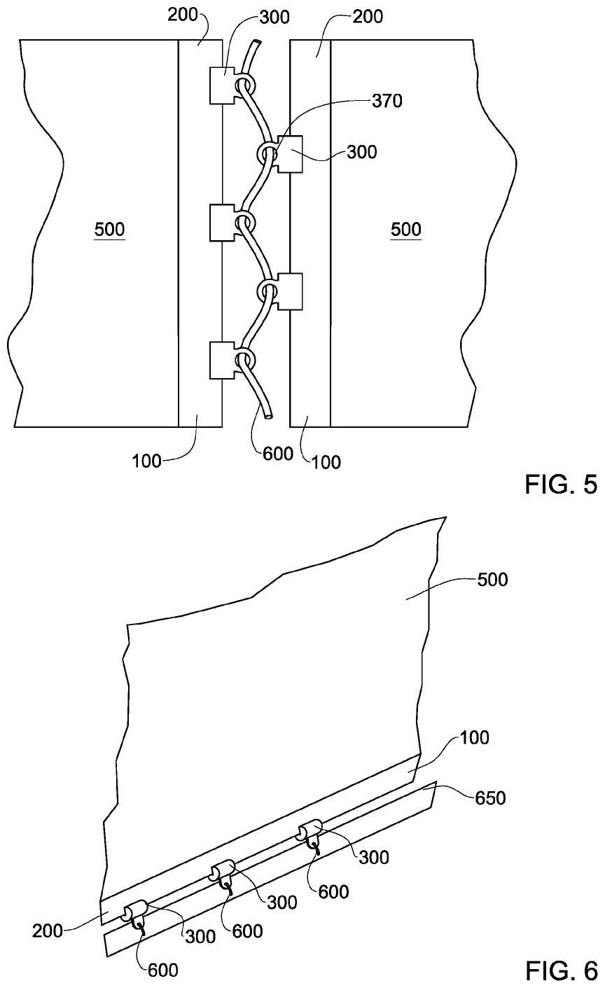

In another example, and referring to FIG. 6, in another application of the above example, one panel 500 is secured to a bracket 650 having a plurality of connection elements 600, each connection element 600 being in the form of one or more hooks. This securing is accomplished by hooking each hook through the respective openings 370 of the respective engagement elements 300 of the respective mounting strip 100 of the panel 500.

An alternative variation of the example of engagement elements 300 of FIGS. 4(a) to 4(d) is illustrated in FIGS. 7(a) to 7(d). In the example of FIGS. 7(a) to 7(d) the relative thickness of the corresponding loop structure 360, in particular of C-shaped part 364 relative to the outer diameter or to the longitudinal dimension K of the body 325, is greater than in the example of FIGS. 4(a) to 4(d). By way of non-limiting example, FIGS. 7(b), 7(c), 7(d) provide dimensional data (in mm) for various parts of the engagement element 300 (with tolerance of, for example, ±0.05), according to one implementation of this variation of the example of FIGS. 4(a) to 4(d). In yet other alternative implementations of this variation of the example of FIGS. 4(a) to 4(d), the dimensional data can be changed pro-rata, for example all annotated dimensions can be increased or decreased in the same proportion, for example can be increased by 50%, 100%, 150%, 200% and so on, or decreased by 10%, 25%, 50% and so on.

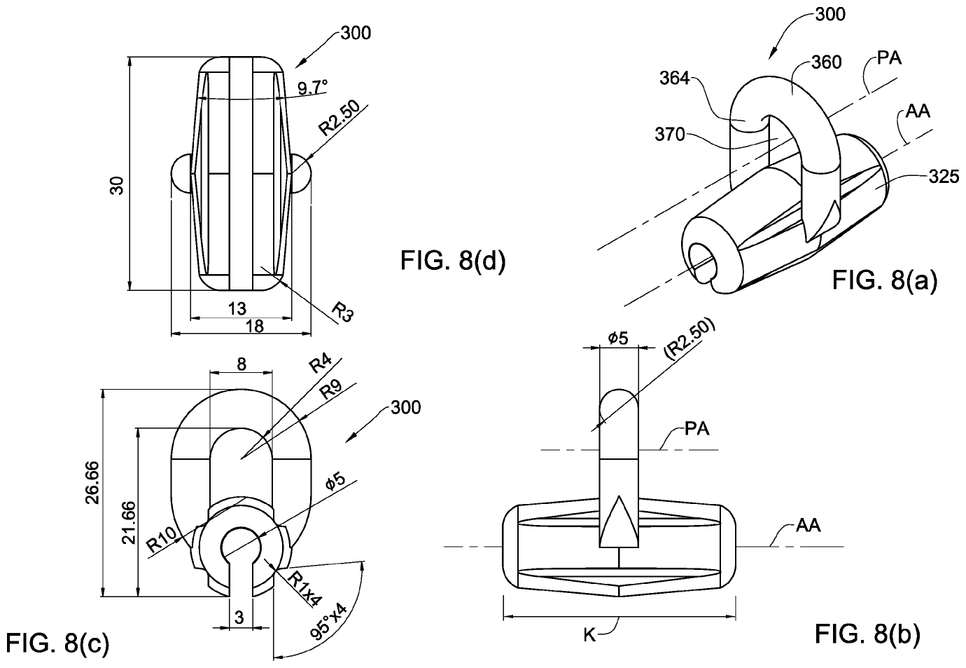

Another alternative variation of the example of engagement elements 300 of FIGS. 4(a) to 4(d) is illustrated in FIGS. 8(a) to 8(d). In the example of FIGS. 8(a) to 8(d) the relative orientation of the corresponding loop structure 360, in particular of C-shaped part 364 relative to the body 325, is different from that in the example of FIGS. 4(a) to 4(d). In the example of FIGS. 8(a) to 8(d) the relative orientation of the corresponding loop structure 360, in particular of C-shaped part 364 relative to the body 325, is such that the opening 370 of the loop structure 360 allows for passage of the connection element 600 through the loop structure 360 along a passage axis PA, wherein the passage axis PA is nominally non-orthogonal to the longitudinal axis AA of the body 325. In the example of FIGS. 8(a) to 8(d) the passage axis PA is nominally parallel to the longitudinal axis AA of the body 325, while in alternative variations of this example, the passage axis PA can be at any acute angle to the longitudinal axis AA of the body 325, for example any angle including any one of 5°, 10°, 15°, 20°, 25°, 30°, 35°, 40°, 45°, 50°, 55°, 60°, 65°, 70°, 75°, 80°, 85°. Alternatively or additionally, the aforesaid acute angle can be in any one of the following ranges: 5° to 85°, 10° to 80°, 15° to 75°, 20° to 70°, 25° to 65°, 30° to 60°, 35° to 55°, 40° to 50°, 5° to 45°, 45° to 85°, 5° to 65°. By way of non-limiting example, FIGS. 8(b), 8(c), (d) provide dimensional data (in mm) for various parts of the engagement element 300 (with tolerance of, for example, ±0.05), according to one implementation of this variation of the example of FIGS. 4(a) to 4(d). In yet other alternative implementations of this variation of the example of FIGS. 4(a) to 4(d), the dimensional data can be changed pro-rata, for example all annotated dimensions can be increased or decreased in the same proportion, for example can be increased by 50%, 100%, 150%, 200% and so on, or decreased by 10%, 25%, 50% and so on.

It is to be noted that in yet other alternative variations of the above examples, the corresponding loop structure is in the form of a ring of material that while fully circumscribing and thereby defining the respective opening, is nevertheless in a “split ring” configuration, or “cotter ring” configuration, or “kickout ring” configuration. In such configurations, the corresponding loop structure is in the form of an open helical loop, allowing for the insertion of another closed loop or ring into the loop structure in general orthogonal configuration. Alternatively, there may be provided two partial-rings placed adjacent to one another, with or without a gap in between.

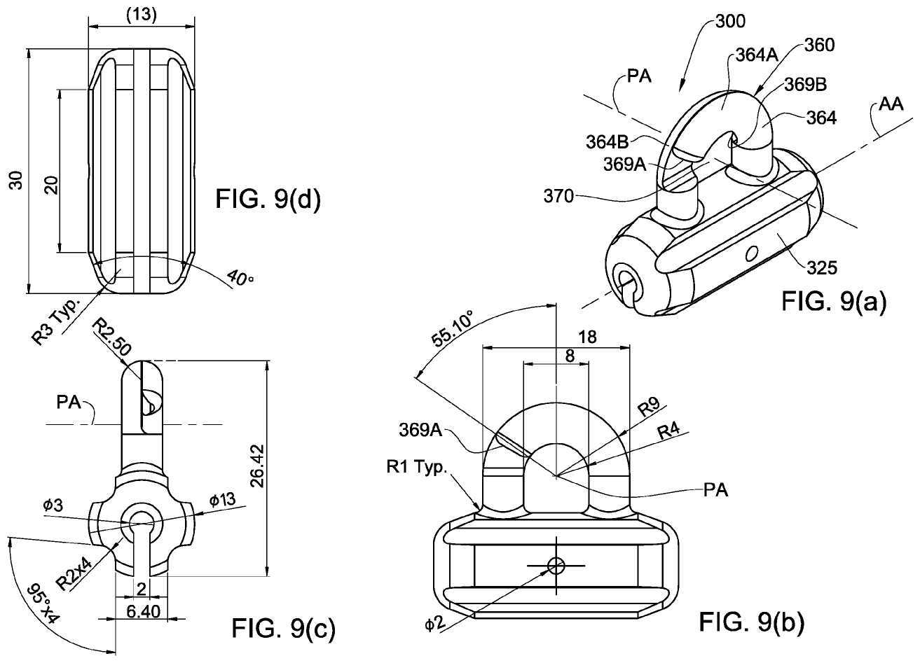

Thus, another alternative variation of the example of engagement element 300 of FIGS. 4(a) to 4(d) is illustrated in FIGS. 9(a) to 9(d). In the example of FIGS. 9(a) to 9(d) the corresponding loop structure 360, in particular of C-shaped part 364 relative to the body 325, is different from that in the example of FIGS. 4(a) to 4(d). In the example of FIGS. 9(a) to 9(d) the corresponding loop structure 360, in particular C-shaped part 364, is in the form of an open helical loop. More specifically, the corresponding loop structure 360, in particular of C-shaped part 364, is formed as two J-shaped parts 364A, 364B in transverse partial overlapping relationship. In this example the two J-shaped parts 364A, 364B are in abutment transversely, while in alternative variations of this example a small transverse gap can be provided between the two J-shaped parts 364A, 364B (see below for example regarding the example of FIG. 9(e)). The partial transverse overlap between the two J-shaped parts 364A, 364B provides for corresponding loop openings 369A, 369B, respectively, that allows access to the opening 370 via resilient transient separation of the two J-shaped parts 364A, 364B. Thus, another ring element (not shown) can be looped into engagement with the loop structure 360, in particular with C-shaped part 364. In any case, the opening 370 of the loop structure 360 allows for passage of the connection element 600 (or another ring element) through the loop structure 360 along a passage axis PA. In the example of FIGS. 9(a) to 9(d), the passage axis PA is nominally orthogonal to the longitudinal axis AA of the body 325; in alternative variations of this example the corresponding open loop structure of the corresponding loop structure 360 can be similar to the example of FIGS. 8(a) to 8(d), for example, and in such a case the passage axis PA is nominally parallel to the longitudinal axis AA of the body 325; in yet other alternative variations of this example, the passage axis PA can be at any acute angle to the longitudinal axis AA of the body 325, for example any angle including any one of: 5°, 10°, 15°, 20°, 25°, 30°, 35°, 40°, 45°, 50°, 55°, 60°, 65°, 70°, 75°, 80°, 85°. Alternatively or additionally, the aforesaid acute angle can be in any one of the following ranges: 5° to 85°, 10° to 80°, 15° to 75°, 20° to 70°, 25° to 65°, 30° to 60°, 35° to 55°, 40° to 50°, 5° to 45°, 45° to 85°, 5° to 65°.

FIG. 9(e) shows an alternative arrangement for an engagement element 300, having a body 325 comprising a longitudinal axis AA. The corresponding loop structure 360, in particular of C-shaped part 364 relative to the body 325, is different from that in the example of FIGS. 9(a) to 9(d). In the example of FIG. 9(e), the corresponding loop structure 360, is in the form of two partial-rings 364A, 364B having a broken-U-type shape, parallel to one another and spaced by a gap G. In this example, the two broken-U-shaped parts 364A, 364B each comprise a loop opening 369A, 369B, respectively in the broken-part of the U-shape, that allows access to the opening 370. Thus, another ring element (not shown) can be looped into engagement with the loop structure 360. In any case, the opening 370 of the loop structure 360 allows for passage of the connection element 600 (or another ring element) through the loop structure 360 along a passage axis PA. The two loop openings 369A, 369B of the two partial-rings 364A, 364B having a broken-U-type shape are at opposite sides of the loop structure 360, because the two partial-rings 364A, 364B face in opposite direction. In this way, a connection element 600 (or another ring element) passing through the opening 370 cannot be accidentally disengaged therefrom by sliding to one side or the other. In the example of FIG. 9(e), the passage axis PA is nominally parallel to the longitudinal axis AA of the body 325; in alternative variations of this example the corresponding open loop structure of the corresponding loop structure 360 can be similar to the example of FIGS. 9(a) to 9(d), for example, and in such a case the passage axis PA is nominally orthogonal to the longitudinal axis AA of the body 325; in yet other alternative variations of this example, the passage axis PA can be at any acute angle to the longitudinal axis AA of the body 325, for example any angle including any one of: 5°, 10°, 15°, 20°, 25°, 30°, 35°, 40°, 45°, 50°, 55°, 60°, 65°, 70°, 75°, 80°, 85°. Alternatively or additionally, the aforesaid acute angle can be in any one of the following ranges: 5° to 85°, 10° to 80°, 15° to 75°, 20° to 70°, 25° to 65°, 30° to 60°, 35° to 55°, 40° to 50°, 5° to 45°, 45° to 85°, 5° to 65°. Alternatively or additionally, the two partial-rings 364A, 364B having a broken-U-type shape may be orientated at different angles to one another, such that the passage axis PA may comprise a bend, curve or discontinuity between one partial-ring 364A, 364B and the next.

By way of non-limiting example, FIGS. 9(b), 9(c) and 9(d) provide dimensional data (in mm) for various parts of the engagement element 300 (with general tolerance of, for example, ±0.05), according to one implementation of this variation of the example of FIGS. 4(a) to 4(d). In yet other alternative implementations of this variation of the example of FIGS. 4(a) to 4(d), the dimensional data can be changed pro-rata, for example all annotated dimensions can be increased or decreased in the same proportion, for example can be increased by 50%, 100%, 150%, 200% and so on, or decreased by 10%, 25%, 50% and so on.

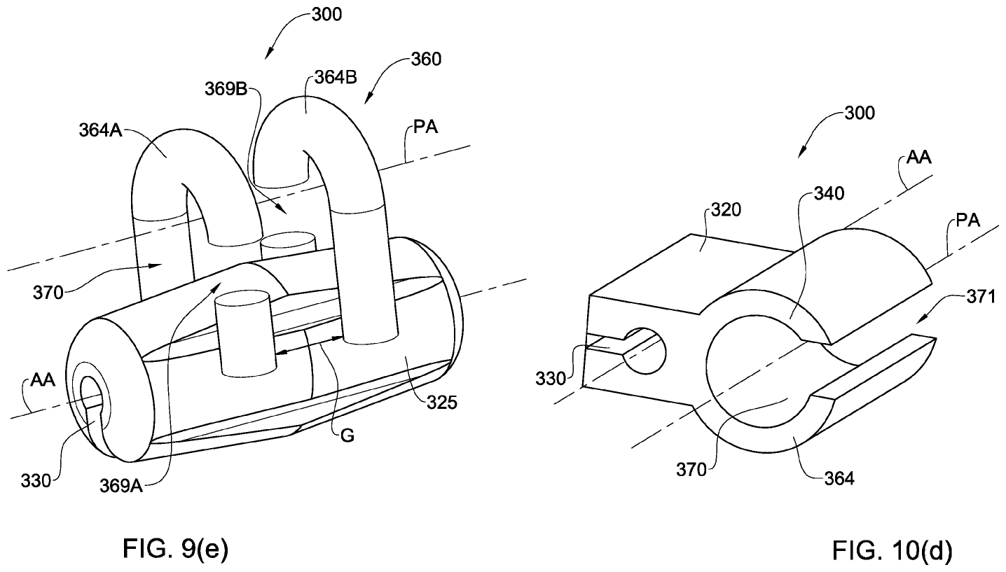

It is to be noted that in yet other alternative variations of the above examples, the corresponding loop structure is in the form of a partial ring of material that only partially circumscribes and thereby defines the respective opening. Thus, another alternative variation of the example of engagement elements 300 of FIGS. 4(a) to 4(d) is illustrated in FIGS. 10(a) to 10(c). In the example of FIGS. 10(a) to 10(c) the corresponding loop structure 360, in particular C-shaped part 364, is different from that in the example of FIGS. 4(a) to 4(d). In the example of FIGS. 10(a) to 10(c) the corresponding loop structure 360, in particular C-shaped part 364, only partially circumscribes the respective opening 370, which, as in other examples, allows for passage of the connection element 600 transversely through side opening 371 (made by the gap in the “C”) and also through the loop structure 360 along a passage axis PA. In the example of FIGS. 10(a) to 10(c) the loop structure 360 is in the form of a “C” or a hook, and allows the corresponding engagement element 300 to be hooked to a suitable structure.

Alternatively, as shown in the example of FIG. 10(d), the corresponding loop structure 360, in particular C-shaped part 364, can be different from that in the example of FIGS. 10(a) to 10(c). In the example of FIG. 10(d), the opening 371 (made by the gap in the “C”) is a central opening rather than a side-opening. The opening 371 allows for passage of the connection element 600 transversely through the opening 371 and also through the loop structure 360 along a passage axis PA. Since the loop structure 360 is in the form of a “C” or a hook, the corresponding engagement element 300 can be hooked, or clipped onto to a suitable structure. For example, a suitable structure can comprise a cable, and the loop structure 360 may be configured to disconnect from the cable, by the cable passing through the gap or opening 371 under applied loads above a pre-determined threshold.

In the examples of FIGS. 10(a) to 10(d) the respective passage axis PA is nominally parallel to the longitudinal axis AA of the body 325. In alternative variations of the example of FIGS. 10(a) to 10(d) the respective passage axis PA is nominally orthogonal to the longitudinal axis AA of the body 325, while in alternative variations of this example, the passage axis PA can be at any acute angle to the longitudinal axis AA of the body 325, for example any angle including any one of 5°, 10°, 15°, 20°, 25°, 30°, 35°, 40°, 45°, 50°, 55°, 60°, 65°, 70°, 75°, 80°, 85°. Alternatively or additionally, the aforesaid acute angle can be in any one of the following ranges: 5° to 85°, 10° to 80°, 15° to 75°, 20° to 70°, 25° to 65°, 30° to 60°, 35° to 55°, 40° to 50°, 5° to 45°, 45° to 85°, 5° to 65°. By way of non-limiting example, FIGS. 8(b), 8(c), (d) provide dimensional data (in mm) for various parts of the engagement element 300 (with tolerance of, for example, ±0.05), according to one implementation of this variation of the example of FIGS. 4(a) to 4(d). In yet other alternative implementations of this variation of the example of FIGS. 4(a) to 4(d), the dimensional data can be changed pro-rata, for example all annotated dimensions can be increased or decreased in the same proportion, for example can be increased by 50%, 100%, 150%, 200% and so on, or decreased by 10%, 25%, 50% and so on.

For example, the engagement elements 300 of the example of FIGS. 10(a) to 10(c) can be affixed with respect to the strip element 200 in an alternating manner, i.e., wherein each successive engagement element 300 in the longitudinal direction AA has the opening 371 of the C-shaped hook facing a direction opposite from the direction faced by the opening 371 of the previous engagement element 300.

In the examples illustrated in FIG. 3(a) to FIG. 10(d) the corresponding engagement elements 300 are contemplated to be unitary structures, in which the anchor portion 320 is integrally formed with the respective engagement portion 340; in particular, the engagement elements 300 are injection molded directly to the strip element 200, as discussed above. However, in alternative variations of the above examples, the anchor portion 320 is not integrally formed with the respective engagement portion 340. Rather, the anchor portion 320 of the engagement elements 300 is injection molded directly to the strip element 200, and the engagement portion 340 (which is manufactured separately from the anchor portion 320) is affixed to the anchor portion 320 after this is injection molded to the strip element 200. Alternatively, the anchor portion 320 of the engagement elements 300 is injection molded directly to the strip element 200 and concurrently also to the engagement portion 340.

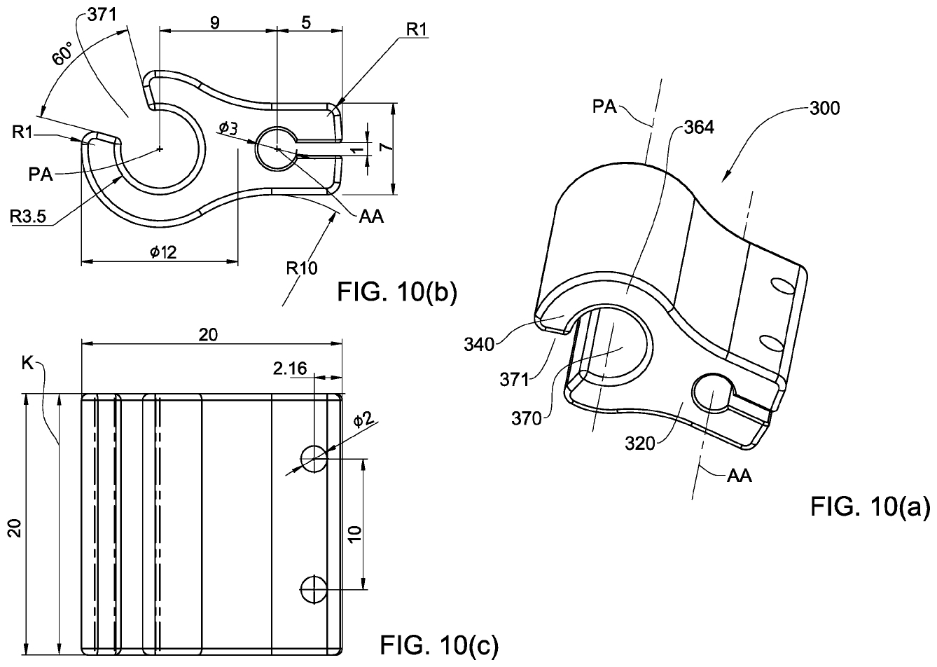

Thus, referring to FIGS. 11(a), 11(b), 11(c) and 11(d), in another alternative variation of the above examples, the respective engagement element 300 comprises an anchor portion 320 in the form of body 325, substantially similar to body 325 as disclosed above for the examples of FIG. 3(a) to FIG. 10(d), mutatis mutandis, with the main difference being that in the example of FIGS. 11(a) to 11(d) there is provided a body interface 400 for affixing to the respective engagement portion 340 which is provided separately from the anchor portion 320.

In the example of FIGS. 11(a), 11(b) and 11(c), the body interface 400 is in the form of a bore, which may be a blind-bore or a through-bore, into the body 325.

In this example, there are a variety of different engagement portions 340, each of which can be affixed to the corresponding body 325. The different engagement portions 340 include: a first engagement portion 340A, a second engagement portion 340B, and a third engagement portion 340C.

In this example, the anchor portion 320 and the engagement portion 340 can be made from the same materials or from different materials. For example, if made from the same materials, these materials can be similar to those disclosed above for the other examples illustrated in FIGS. 1 to 10, mutatis mutandis. For example, if made from different materials, the materials for the anchor portion 320 can be similar to those disclosed above for the other examples illustrated in FIGS. 1 to 10, mutatis mutandis, while the engagement portion 340 can be made from any other material, for example metal, wood, composites, etc.

The anchor portion 320 in this and other examples can be made from the same material as the strip element 200. Alternatively, the anchor portion 320 in this and other examples can be made from a different material from the strip element 200.

The first engagement portion 340A is in the form of a closed loop structure, or closed loop member 360A having an engagement portion interface 420. The engagement portion interface 420 is substantially complementary to the body interface 400 and is configured for affixing to the body interface 400. For example, as shown in FIGS. 11(a) and 11(b), the engagement portion interface 420 comprises an external screw thread, while the body interface 400 is in the form of a bore having an internal screw thread substantially complementary to the aforesaid external screw thread, thereby enabling the first engagement portion 340A to be screwed into the anchor portion 320. In alternative variations of the above example any other suitable arrangement can be used for engagement portion interface 420 and the body interface 400. For example, as shown in FIG. 11(c) the engagement portion interface 420 can comprise a shaft that is received in the body interface 400, for example in a bore provided in the body interface 400, and a suitable adhesive, solder, weld or other material or arrangement can be used to bond the two together. Alternatively or additionally, for example, as shown in FIG. 11(d), the engagement portion interface 420 can comprise a snap-fit arrangement, for example having a semi-circular clasp with two end engagement portions 420a configured to snap-fit into, slide into, or otherwise engage with longitudinal grooves and/or ribs of the body interface 400.

As shown particularly in FIG. 11(d), the second engagement portion 340B is in the form of a loop structure 360B having an engagement portion interface 420. The loop structure 360A is in the form of an open helical loop, allowing for the insertion of another closed loop or ring into the loop structure in general orthogonal configuration. Alternatively, the loop structure may be in the form of two partial-rings placed against one another as described above, for example, as shown in FIG. 10(d), in which case each partial-ring 364A, 364B may be attached via a separate engagement portion interface 420 to the body interface 400. Although the second engagement portion 340B is not depicted in any of FIGS. 11(b) to 11(d), the engagement portion interface 420 can be similar to any of the engagement portion interfaces 420 described above with respect to the first engagement portion 340A, mutatis mutandis, for interfacing with the corresponding body interface 400.

The third engagement portion 340C is in the form of an open loop structure 360C having an engagement portion interface 420. The open loop structure 360C is in the form of a “C” or hook, i.e. in the form of a partial ring of material that only partially circumscribes and thereby defines the respective opening. The engagement portion interface 420 can be similar to any of the engagement portion interfaces 420 disclosed above with respect to the first engagement portion 340A, mutatis mutandis, for interfacing with the corresponding body interface 400.

In the example of FIGS. 11(a) to 11 (d), each one of the different engagement portions 340 (i.e. the first engagement portion 340A, or the second engagement portion 340B, or the third engagement portion 340C) can be affixed to the anchor portion 320 (via the respective engagement portion interface 420 and the body interface 400) at any desired orientation with respect to one another, such that the respective passage axis PA of the respective different engagement portion 340 is nominally orthogonal to the longitudinal axis AA of the body 325. In alternative variations of the examples of FIGS. 11(a) to 11(d), the different engagement portions 340A or 340B or 340C can be affixed at an orientation such that the passage axis PA is nominally parallel to the longitudinal axis AA of the body 325, while in alternative variations of this example, the affixing can be at an orientation such that the passage axis PA can be at any acute angle to the longitudinal axis AA of the body 325, for example any angle including any one of 5°, 10°, 15°, 20°, 25°, 30°, 35°, 40°, 45°, 50°, 55°, 60°, 65°, 70°, 75°, 80°, 85°. Alternatively or additionally, the aforesaid acute angle can be in any one of the following ranges: 5° to 85°, 10° to 80°, 15° to 75°, 20° to 70°, 25° to 65°, 30° to 60°, 35° to 55°, 40° to 50°, 5° to 45°, 45° to 85°, 5° to 65°.

In the example of FIGS. 11(a) to 11(d), each one of the different engagement portions 340 (i.e. the first engagement portion 340A, or the second engagement portion 340B, or the third engagement portion 340C) can be affixed to the anchor portion 320, via any one of the respective engagement portion interfaces 420 and the corresponding body interfaces 400.

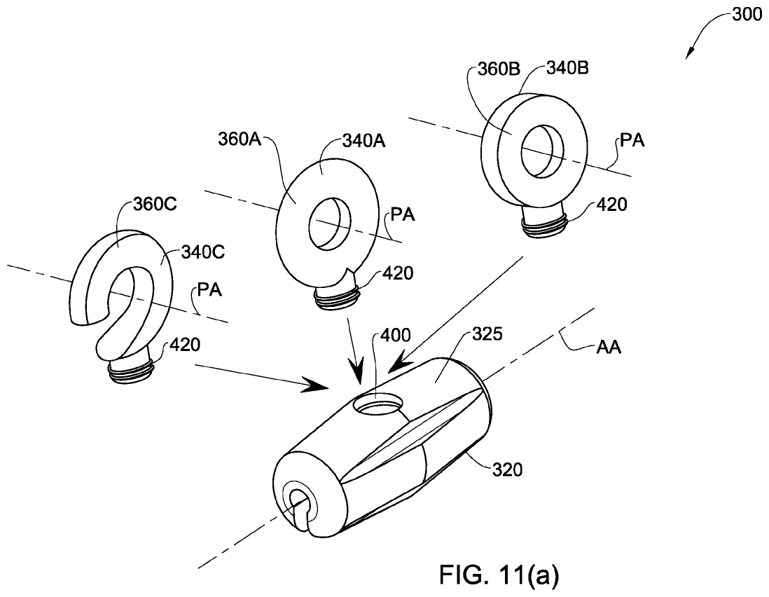

Referring to FIG. 12, in an alternative variation of the above examples, the mounting strip 100 (for example according to any one of the above examples or variations thereof) is not mounted to the panel 500 at an edge thereof, but rather in overlapping relationship with another part of the panel 500 spaced from the edge of the panel 500. In such a case, the longitudinal second edge portion 227 is affixed to a surface of the panel 500 using any suitable fixing method, for example via mechanical fixing (for example staples, stitching, sewing, etc.) or welding (for example ultrasonic welding, heat welding, etc), or via bonding (for example using suitable adhesives optionally including application of heat and/or pressure, e.g. with contact adhesives). On the other hand, the longitudinal first edge portion 217 is not affixed to the panel 500, and thus allows flexibility of movement and orientation of the respective engagement elements 300 with respect to the panel 500.

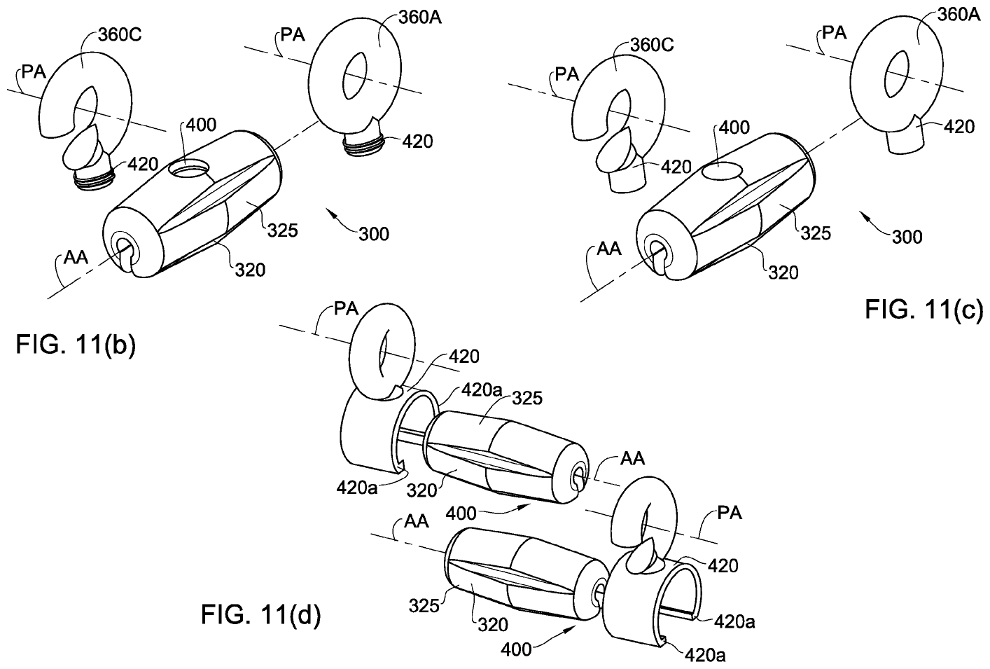

Referring to FIG. 13, in yet another alternative variation of the above examples, the mounting strip 100 (for example according to any one of the above examples or variations thereof) comprises a first plurality of engagement elements 300 affixed at least to the longitudinal first edge 215, including at least a part of the first edge portion 217, in longitudinal serially spaced relationship, i.e., along the longitudinal dimension L of the mounting strip 100. In addition, in the example of FIG. 13, the mounting strip 100 further comprises a second plurality of engagement elements 300 affixed to the longitudinal second edge 225, including at least part of the second edge portion 227, in longitudinal serially spaced relationship, i.e., along the longitudinal dimension L of the mounting strip 100. This arrangement leaves a central portion 228 of the strip element 200 free of said engagement elements 300. The central portion 228 is flanked on either transverse side (longitudinally extending edge) thereof by the longitudinal first edge 215 and longitudinal second edge 225. Also in this example, each engagement element 300 can be formed as an integral or unitary article (or as a two-component article, for example corresponding to the example of FIG. 11, mutatis mutandis) and comprises an anchor portion 320, and an engagement portion 340 projecting outwardly from the anchor portion 320 in a transverse direction away from the strip element 200.

In the example of FIG. 13, the strip element 200 comprises at least one cordelle 230 affixed to the strip element 200 at the longitudinal first edge 215, and at least one cordelle 230 affixed to the strip element 200 at the longitudinal second edge 217. Each such cordelle 230 is continuous and generally co-extensive with the respective longitudinal first edge 215, and longitudinal second edge 225. In alternative variations of this example, one or both such cordelles can be interrupted, and thus there can be one or more first regions of the longitudinal first edge 215 and/or of the longitudinal second edge 225 in which there is no cordelle along the longitudinal first edge 215, respectively interposed with one or more second regions of the longitudinal first edge 215 and/or of the longitudinal second edge 225 in which there is a cordelle along the longitudinal first edge 215 and/or along the longitudinal second edge 225, respectively. While in this example the strip element 200 comprises at least one cordelle 230 along each of the longitudinal first edge 215 and the longitudinal second edge 225, in some alternative variations of this example, the cordelle 230 can be omitted from both or from one of the longitudinal first edge 215 and the longitudinal second edge 225. Each cordelle 230 is configured for reinforcing the respective longitudinal edge portion, in particular the respective longitudinal edge.

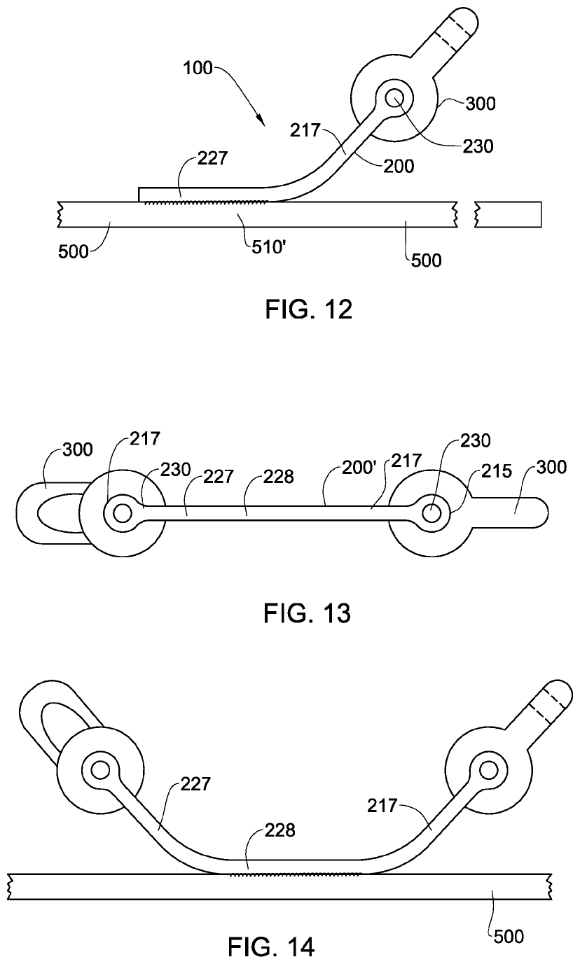

In the example of FIG. 13, and referring also to FIG. 14, the respective mounting strip 100 can be affixed to panel 500 at an edge thereof, or to any other part of the panel 500 spaced from the edge of the panel 500, and in overlapping relationship therewith. In such cases, the central portion 228 is affixed to a surface of the panel 500 using any suitable fixing method, for example via mechanical fixing (for example staples, stitching, sewing, etc.) or welding (for example ultrasonic welding, heat welding, etc), or via bonding (for example using suitable adhesives optionally including application of heat and/or pressure, e.g. with contact adhesives). On the other hand, the longitudinal first edge portion 217 and the longitudinal second edge portion 227 are not affixed to the panel 500, and thus allows flexibility of movement and orientation of the respective engagement elements 300 with respect to the panel 500.

Alternatively, the mounting strip 100 according to the example of FIG. 13, can be used as a stand-alone item, and can be used for example as a multi-use belt or strap, for facilitating mounting multiple items thereto, for example.

It is to be noted that in each of the examples disclosed herein and alternative variations thereof, in particular with reference to FIGS. 1 to 14, each respective mounting strip can include a plurality of engagement element 300 in which all the engagement element 300 that are affixed to the respective strip element 200 are identical to one-another.

Alternatively, in each of the examples disclosed herein and alternative variations thereof, in particular with reference to FIGS. 1 to 14, each respective mounting strip can include a plurality of engagement element 300 in which all the engagement element 300 that are affixed to the respective strip element 200 are not all identical to one another, and in fact can include different examples of the engagement element 300 affixed to the respective strip element 200. For example, one such mounting strip 100 can include one or more engagement elements 300 corresponding to the example of FIGS. 4(a) to 4(d), and/or one or more engagement elements 300 corresponding to the example of FIGS. 4(a) to 4(d), one or more engagement elements 300 corresponding to the example of FIGS. 7(a) to 7(d), one or more engagement elements 300 corresponding to the example of FIGS. 8(a) to 8(d), one or more engagement elements 300 corresponding to the example of FIGS. 9(a) to 9(d), one or more engagement elements 300 corresponding to the example of FIG. 9(e); one or more engagement elements 300 corresponding to the example of FIGS. 10(a) to 10(c), one or more engagement elements 300 corresponding to the example of FIG. 10(d); one or more engagement elements 300 corresponding to the example of FIGS. 11(a) to 11(e). As another example, another such mounting strip 100 can include one or more engagement elements 300 corresponding to the example of any one or more of FIGS. 11(a) to 11(d), having a variety of engagement portions 340A, 340B and/or 340C. Similarly, the respective strip element 200 can correspond to the example of FIGS. 1(a) and 1(b) or the example of FIGS. 2(a) and 2(b), for example. Furthermore for example, each such mounting strip 100 can include a plurality of engagement elements 300 on one or on both longitudinal edges of the respective strip element 200.

In at least some examples, the mounting strip 100 can further include one or more engagement elements 300 at one or both longitudinal ends of the respective strip element 200.

In at least some examples, the mounting strip 100 can further include one or more clasping arrangements at one or both longitudinal ends of the respective strip element 200.

As is evident from the above disclosure, in at least some examples according to the above aspects of the presently disclosed subject matter, the mounting strip 100 is provided as a stand-along article, different from the panel 500, itself. This arrangement can allow for a great amount of versatility, particularly in the use of the mounting strip 100 per se, and also in the use of the mounting strip 100 for indirectly providing a panel 500 with engagements elements 300. For example, any one of a variety of mounting strips 100 (for example each having strip elements 200 of different widths and/or having different types of engagements elements 300) can be chosen for affixing to any particular configuration or type of panel 500, and furthermore such affixing can be made easily and in a timely manner. Furthermore, in at least some examples according to the above aspects of the presently disclosed subject matter, the mounting strip 100 can provide further mechanical strength to the panel 500. Furthermore, in at least some examples according to the above aspects of the presently disclosed subject matter, a damaged mounting strip 100 that is already affixed to a panel 500 can be replaced with another mounting strip 100, by first removing all or part of the damaged mounting strip 100, and in at least some such cases this can be achieved without significantly reducing the mechanical integrity of the assembly with the panel 500.

However, in at least some other examples according to other aspects of the presently disclosed subject matter, the strip element 200 can be in the form of the panel 500 as described in more detail herein, thus the strip element 200 is not different from the panel 500. In such cases the engagement elements 300 are thus injection molded essentially directly to the respective panel element 500. However, at least some of the features that arise from having the mounting strip 100 produced as an independent article, separate and different from the panel element 500, for example as in the examples disclosed above with reference to the attached figures, are not applicable to at least some applications of this other aspect of the presently disclosed subject matter in which strip element 200 is in the form of the panel 500.

Finally, it should be noted that the word “comprising” as used throughout the appended claims is to be interpreted to mean “including but not limited to”.

While there has been shown and disclosed examples in accordance with the presently disclosed subject matter, it will be appreciated that many changes may be made therein without departing from the scope of the presently disclosed subject matter as set out in the claims.

1. A mounting strip comprising a strip element and a plurality of engagement elements, each said engagement element including:
an anchor portion configured for anchoring the respective engagement element to the strip element; and
an engagement portion including a through-opening;
wherein at least the anchor portion is provided as an injection molded article, directly molded onto said strip element.

2. The mounting strip according to claim 1, wherein the mounting strip comprises an elongate configuration having a longitudinal dimension at least twice a width dimension thereof.

3. The mounting strip according to any one of claim 1 or 2 wherein the mounting strip is configured for affixing with respect to a panel element.

4. The mounting strip according to any one of claims 1 to 3, wherein the mounting strip is configured as a multi-purpose belt or strap, for facilitating mounting multiple items thereto.

5. The mounting strip according to any one of claims 1 to 4, wherein each said engagement element is provided as an injection molded article, directly molded onto said strip element.

6. The mounting strip according to any one of claims 1 to 4, wherein each said engagement portion is detachably attachable to a respective one of the anchor portions.

7. The mounting strip according to any one of claims 1 to 4 and 6, wherein the anchor portion further comprises a body interface and the engagement element further comprises an engagement portion interface configured to interface with and be connected to the body interface.

8. The mounting strip according to claim 7, wherein the interfacing is via any one or more of a screw and thread arrangement, an adhesive connection between a protrusion and a recess or a snap-fit arrangement.

9. The mounting strip according to any one of claims 1 to 8, wherein the strip element comprises a plurality of holes at spaced apart locations along the strip element;
wherein the anchor portions are each formed superposed at one of the plurality of holes, having a first anchor portion and second anchor portion arranged above and below the strip element respectively, such that the first and second anchor portions are connected to one another via a connected portion passing through one of the holes.

10. The mounting strip according to any one of claims 1 to 9, wherein the mounting strip comprises at least one cordelle at an edge of the strip element, and a slot in each of the anchor portions, the slot comprising a circular portion arranged to engage with the cordelle.

11. The mounting strip according to any one of claims 1 to 10, wherein said through opening defines a passage axis different from a longitudinal axis of the anchor portion.

12. The mounting strip according to claim 11, wherein said passage axis is substantially parallel to said longitudinal axis.

13. The mounting strip according to claim 11, wherein said passage axis is substantially orthogonal to said longitudinal axis.

14. The mounting strip according to claim 11, wherein said passage axis is orientated at an acute angle to said longitudinal axis.

15. The mounting strip according to any one of claims 1 to 14, wherein said engagement portion includes a loop structure defining said through-opening therein.

16. The mounting strip according to claim 15, wherein said loop structure is in the form of a body of material at least partially circumscribing and thereby defining the through-opening.

17. The mounting strip according to claim 16, wherein the body of material comprises at least one partial ring-shaped structure having an opening in the ring structure, the opening being a gap either at a central portion of the ring distal from the anchoring portion, or at a side portion of the ring between the central portion and the anchoring portion.

18. The mounting strip according to claim 17, wherein the relative sizes of the gap and the through-opening are such as to allow the loop-structure to engage with a cable passing through the through-opening, and to allow the loop-structure to become disconnected from the cable via the gap under loads above a pre-determined threshold.

19. The mounting strip according to any one of claims 15 to 18, wherein a transverse cross-sectional area of the through-opening is configured to be larger than a transverse cross-sectional area of a connection element configured to be passed therethrough.

20. The mounting strip according to claim any one of claims 15 to 19, wherein said loop structure is in the form of a body of material fully circumscribing and defining the through-opening;
wherein a first part of the loop structure is defined by the base element, while a second part of the loop structure is defined by a C-shaped element joined to the base element; and
wherein the through-opening is configured to allow passage of a connection element through the loop structure along a passage axis.

21. The mounting strip according to any one of claims 1 to 20, comprising the engagement elements arranged on a first edge portion of the strip element.

22. The mounting strip according to claim 21, wherein the mounting strip comprises two layers joined together at the first edge portion and, when not connected to a panel, separated at a second edge portion of the strip element.

23. The mounting strip according to any one of claims 1 to 21, wherein the engagement elements are a first set of engagement elements, the mounting strip further comprising a second set of engagement elements arranged on a second edge portion of the strip element, the second edge portion being located at an edge of the strip opposite from that at which the first edge portion is located.

24. A mounting strip comprising a strip element and a plurality of engagement elements, each said engagement element including:
an anchor portion configured for anchoring the respective engagement element to the strip element; wherein at least the anchor portion is provided as an injection molded article, directly molded onto said strip element; and wherein, in use, the anchor portion is configured to interface with an engagement portion.

25. The mounting strip according to claim 24, further including an engagement portion provided for each anchor portion, each engagement element comprising the anchor portion and the engagement portion;
wherein each engagement portion comprises a through-opening.

26. A mounting strip comprising a strip element and a plurality of engagement elements, each said engagement element including:
an anchor portion configured for anchoring the respective engagement element to the strip element; and
an engagement portion including a through-opening;
wherein at least the anchor portion is provided as an injection molded article, directly molded onto said strip element
and wherein the mounting strip is the form of a panel element.

27. An assembly including a panel element and at least one mounting strip, wherein the least one mounting strip is affixed with respect to the panel element, the mounting strip being as defined according to any one of claims 1 to 25.

28. The assembly according to claim 27, wherein the mounting strip is affixed at a second edge portion thereof to the panel element.

29. The assembly according to claim 27 or 28, wherein the mounting strip further comprises a central portion free of said engagement elements, wherein the mounting strip is affixed at the central portion thereof to the panel element.

30. The assembly according to any one of claims 27 to 29, wherein the mounting strip is affixed to an edge of the panel element, or to a portion of the panel element spaced from an edge thereof.

31. The assembly according to claim 30 when dependent on claim 22, wherein the mounting strip is affixed to an edge of the panel element, the edge of the panel element being affixed in-between the two layers of the mounting strip at the second edge portion thereof.

32. The assembly according to any one of claims 27 to 31, wherein affixing comprises at least one of sewing, stapling welding, melting or adhering.

33. The assembly according to any one of claims 27 to 32, wherein the panel element comprises at least one further said mounting strip affixed thereto.

34. A method for providing a plurality of engagement elements on a strip element, the engagement elements each comprising an anchor portion configured for anchoring the respective engagement element to the strip element; and an engagement portion including a through-opening, the method comprising:
injection molding a plurality of anchor portions spaced apart along an edge of the strip element; and
providing an engagement portion for each anchor portion.

35. The method according to claim 34, further comprising at least one of injection molding, interfacing or connecting, each of the engagement portions to a respective one of the anchor portions.

36. The method according to claim 34 or 35, wherein the engagement and anchor portions are formed in a single step by injection molding.

37. The method according to any one of claims 34 to 36, further comprising:
providing a plurality of holes at spaced apart locations along the strip element; and
forming each of the anchor portions superposed at one of the holes, having a first anchor portion and second anchor portion arranged above and below the strip element respectively, such that the first and second anchor portions are connected to one another via a connected portion passing through one of the holes.

38. The method according to any one of claims 34 to 37, further comprising:
providing a cordelle at an edge of the strip element, and a slot in each of the anchor portions, the slot comprising a circular portion arranged to engage with the cordelle.

39. A method for fixing a mounting strip to an edge of a panel element, or to a portion of a panel element spaced from an edge thereof, comprising:
providing a mounting strip as defined in any one of claims 1 to 25, the method comprising affixing the mounting strip to a panel element.

40. The method according to claim 39, wherein affixing comprises at least one of sewing, stapling, welding, melting or adhering.

41. The method according to claim 39 or 40, wherein affixing comprises affixing an edge of the mounting strip, or a central portion of the mounting strip, to an edge of a panel element, or to a portion of a panel element spaced from an edge thereof.

42. A structure comprising:
an assembly as defined in any one of claims 27 to 33;
a plurality of mounting points; and
at least one connection element;
wherein the engagement portions of the engagement elements of the assembly are connected to the plurality of mounting points by the at least one connection element.

43. The structure according to claim 42, wherein the at least one connection element comprises a cord element threaded in an alternating fashion between the mounting points and the loop structures of the engagement portions.

44. The structure according to claim 42, wherein the at least one connection element comprises a plurality of hooks, each arranged to connect one of the loop structures of the engagement portions to one of the mounting points.
